(19) United States
(12) Patent Application Publication
(10) Pub. No.: US 2006/0093931 A1
(43) Pub. Date: May 4, 2006

(54) Organic photoconductor, image forming method, image forming apparatus and process cartridge

(76) Inventor: Akihiko Itami, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 10/983,313

(22) Filed: Nov. 4, 2004

(51) Int. Cl. G03G 5/00

(52) U.S. Cl. 430/66; 430/56; 430/58.05

(57) ABSTRACT

An organic photoconductor containing a conductive support having thereon a photoconductor layer, wherein the creep ratio of the surface of the photoconductor layer is not less than 1% and less than 3.5%, and the surface roughness Ra is not less than 0.02 μm and less than 0.1 μm.

### FIELD OF THE INVENTION

The present invention relates to an organic photoconductor used in the field of copying machines and printers, an image forming method using the same, an image forming apparatus and a process cartridge.

### BACKGROUND OF THE INVENTION

In recent years, the electrophotographic photoconductors containing organic photoconductive substances have been employed over the most extensive range. The organic photoconductor (hereinafter also referred to as “photoconductor”) has advantages over other types of photoconductor, such as easier development of materials conforming to various types of light sources ranging from visible light to infrared light, possible selection of materials free of environmental pollution and lower production costs. However, the organic photoconductor is characterized by greater adhesion with toner made of the same organic substance, susceptibility of a toner film being formed on the photoconductor, poorer mechanical strength, and susceptibility to deterioration or damage on the surface of the photoconductor at the time of copying or printing of multiple sheets.

One of the ways to ensure easy cleaning of the toner remaining on the aforementioned organic photoconductor and to improve the wear resistance of the organic photoconductor is allow silica particles to be incorporated in the extreme surface of the photoconductor, thereby improving the mechanical strength on the surface of the photoconductor and upgrading the durability. This method is reported, for example, in the Official Gazette of Japanese Patent Tokkaisho 56-117245, the Official Gazette of Japanese Patent Tokkaisho 63-91666, and the Official Gazette of Japanese Patent Tokkaihei 1-205171.

Further, the hydrophobic silica particles formed by treating the aforementioned silica particles with silane coupling agent are incorporated in the extreme surface of the photoconductor to improve the mechanical strength of the photoconductor and to upgrade the durability of the photoconductor by providing lubricating properties. This method is reported in the Official Gazette of Japanese Patent Tokkaisho 57-176057, the Official Gazette of Japanese Patent Tokkaisho 61-117558 and the Official Gazette of Japanese Patent Tokkaihei 3-155558.

Further, to improve the organic photoconductor, there has been a strong demand for minimizing the wear due to the scratching of the cleaning blade and others. The possibility of various techniques has been studied to meet this demand. One of the approaches is to allow fine particles to be incorporated in the surface of the photoconductor, thereby reducing the friction with the blade. For example, the art of incorporating the fine particles of alkylsyl sesquioxane resin in the photoconductor layer is disclosed in the Official Gazette of Japanese Patent Tokkaihei 5-181291.

However, addition of fine particles on the order of submicron does not always lead to improvement of cleaning performances. Rather, it increases the surface roughness of the photoconductor and causes chipping or wear of the edge of the cleaning blade. Accordingly, this method causes cleaning failure according to the prior art.

To address the aforementioned problem of chipping of the cleaning blade, a solution has been proposed, wherein inorganic hydrophobic silica particles are added to the surface layer of the photoconductor so that surface roughness is kept within a specific range, whereby the cleaning performance is improved. For example, an average surface roughness Ra of 5-μm square is specified as 1.5 through 100 nm in the Official Gazette of Japanese Patent Tokkai 2001-265040.

However, damage by a sharp substance such as a separation claw as well as wear can be mentioned as an important factor that may deteriorate the durability of the organic photoconductor. A deep damage is produced on the surface of the photoconductor by a sharp substance such as talc contained in such a material as a developer and a transfer material or the separation claw of transfer material, and cleaning performances are damaged. Not only that, it will appear as a streak-like defect of the half-tone image on such a position as the separation claw that frequently comes locally in contact with other objects.

In view of the prior art described above, it is an object of the present invention to provide an organic photoconductor capable of producing an electrophotographic image of excellent sharpness by improving the toner transfer properties on a photoconductor and facilitating the removal of remaining toner, as well as by improving the scratch resistance of the photoconductor. The object of the present invention also includes supply of an image forming method using this organic photoconductor, an image forming apparatus and a process cartridge.

### SUMMARY OF THE INVENTION

The present invention specifies the specific creep ratio of an organic photoconductor (creep ratio when a Vickers indenter has been forced inside at a load of 20 mN) and the specific surface roughness Ra, as well as the particle diameter of an inorganic fine particle, as required, and hence provides an organic photoconductor capable of producing an electrophotographic image of excellent sharpness by improving the toner transfer properties on a photoconductor and facilitating the removal of remaining toner, as well as by improving the scratch resistance of the photoconductor.

The aforementioned structures of the organic photoconductor of the present invention ensure improved toner transfer properties, easier removal of remaining toner and greater resistance to damage. The following provides detailed description of the preferred embodiment of the present invention:

### BRIEF DESCRIPTION OF THE DRAWINGS

FIG. 1 is a schematic view representing the functions of an image forming apparatus of the present invention;

FIG. 2 is a plan showing a separation jaw unit;

FIG. 3 is a side view showing a separation jaw unit; and

FIG. 4 is a side view showing a separation jaw.

FIG. 5 is the relationship among applied load time (t1), holding time (t2) h1 and h2.

### PREFERRED EMBODIMENT OF THE INVENTION

The organic photoconductor of the present invention provides the optimum viscoelastic properties from the surface of a photoconductor in such a way that the characteristic of a certain plastic deformation (1% or more to 3.5% exclusive), i.e. creep ratio, is assigned to an indenter of a certain weight (load: 20 mN) applied from the surface of the photoconductor, and the surface roughness Ra is kept at 0.02 μm or more to 0.1 μn exclusive, whereby improved toner transfer properties and easier removal of remaining toner as well as greater resistance to damage are ensured, and hence an electrophotographic image of excellent sharpness is provided.

The word “creep ratio” appearing in the present description refers to the value obtained by using the following equation for calculation of the measurements using a microscopic hardness measuring instrument (by Fischer Instruments) conforming to the hardness test method based on the Fischerscope H100V (International Organization for Standardization (ISO): 14577 (1-3)):
CHU (creep ratio)={(h2−h1)/h1}×100 (%)

where h1: indentation depth when the applied load (20 mN) has been reached (5 seconds from start of applying loads), and

h2: indentation depth after holding (5 sec.)

The following describes the measurement conditions for this case:

Indenter used: Diamond, Vickers indenter

Load condition: A test piece was mounted on the H100V unit and the Vickers indenter was forced inside from the test piece surface at the rate of 4 mN/sec. in the direction perpendicular to the test piece.

Load time: 5 sec.

Holding time: 5 sec.

Load removal: Load was removed at the same rate as that of the load.

Test piece: The aforementioned organic photoconductor was arranged on a flat aluminum plate, and was dried to prepare the test piece.

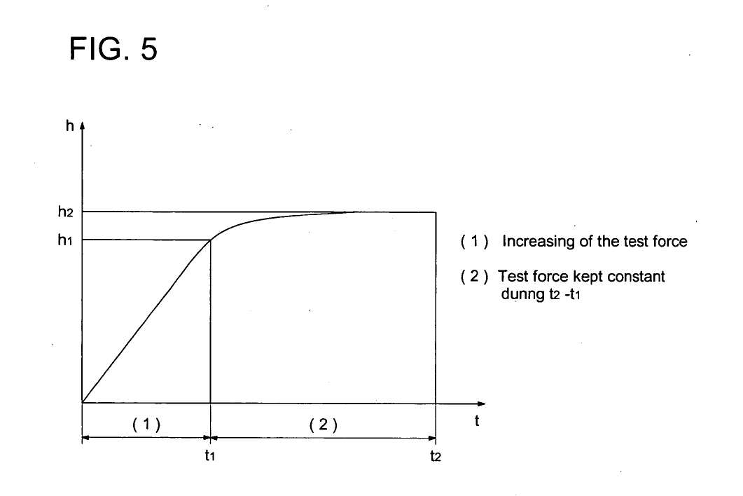

FIG. 5 shows the relationship among applied load time (t1), holding time (t2) h1 and h2.

In FIG. 5, during the time period (1) of five seconds from the start of load application, the load was applied at 4 mN/sec. The load applied at t1 was 20 mN, and the indentation depth was h1.

During the time period (2) of five seconds (t2) from t1, the applied load was constant at 20 mN. The load applied at t2 was 20 mN, and the indentation depth at t2 was h2.

The creep ratio indicates the ease at which permanent deformation occurs. The greater this value, the softer the test piece. This signifies that the edge of the cleaning blade cuts more easily into the photoconductive layer of the photoconductor having a greater creep ratio.

The specific organic photoconductor having the creep ratio and surface roughness Ra of the present invention preferably contains an electric charge generating layer arranged on a conductive support and multiple electric charge transport layers arranged thereon, wherein the topmost layer of the electric charge transport layers is a surface layer, which contains highly elastic binder resins and hydrophobic inorganic fine particles. Highly elastic binder resins include the following copolymer polycarbonates:

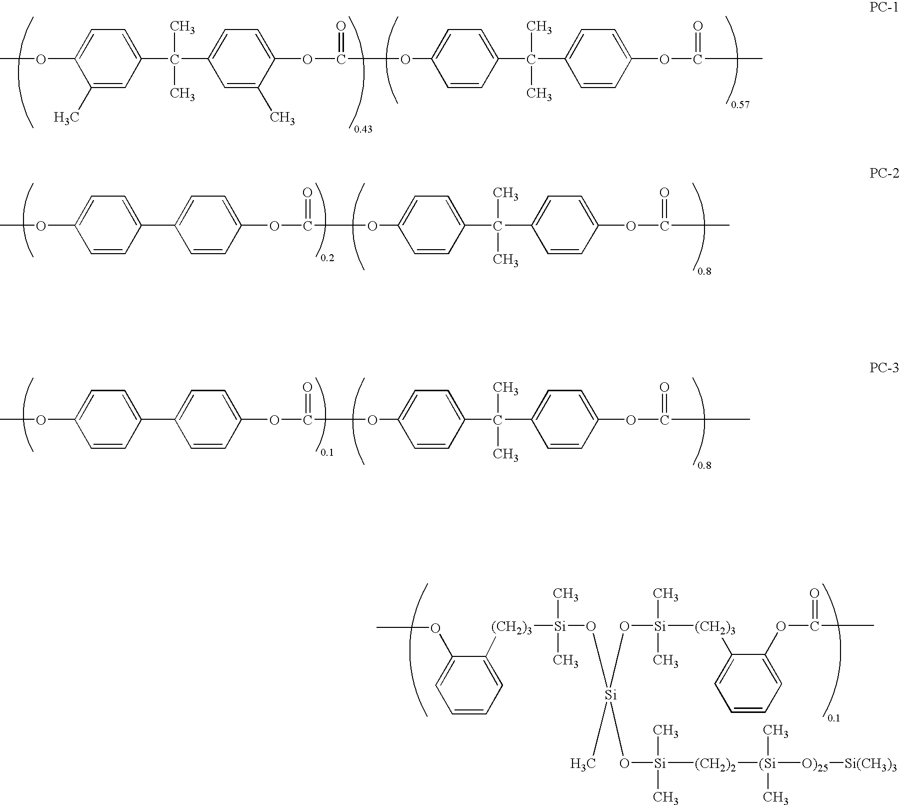

In the meantime, hydrophobic fine particles preferably have a number average primary particle diameter of 10 nm or more to 100 nm exclusive, more preferably have a number average particle diameter of 10 nm or more without exceeding 90 nm, and most preferably have a number average particle diameter of 10 nm or more to 50 nm exclusive. It goes without saying that this electric charge transport layer contains electric charge transport substances as other components. When the number average primary particle diameter of the inorganic particles contained in the surface layer is less than 10 nm, minute irregularities are not formed on the surface of the photoconductor. There is not much effect in the improvement of toner transfer properties and cleaning performances. In the case of inorganic particles each having a number average particle diameter of 10 nm or more, wear of the cleaning blade tends to increase, and cleaning performances tend to deteriorate.

The surface layer, having the aforementioned copolymer polycarbonates and the hydrophobic fine particles having a number average particle diameter of 10 nm or more to 100 nm exclusive, mixed on the electric charge transport layer as a surface layer thereof, acquires membranous physical properties by optimization of their quantitative ratio, wherein creep ratio is 1% or more to 3.5% exclusive and the surface roughness Ra is 0.02 μm or more to 0.1 μm exclusive.

The creep ratio of the present invention is 1% or more to 3.5% exclusive, but more preferably, it should be 2.0% or more without exceeding 3.2%. The surface roughness Ra is 0.02 μm or more to 0.1 μm exclusive, but more preferably, it should be 0.03 μm or more without exceeding 0.085 μm.

The inorganic particles having a number average particle diameter of 10 nm or more to 100 nm exclusive preferably include fine particles of silica, zinc oxide, titanium oxide, tin oxide, antimony oxide, indium oxide, bismuth oxide, indium oxide formed by doping zinc, tin oxide formed by doping antimony and tantalum, zirconium oxide. Of these types of particles, the hydrophobic silica with its surface made hydrophobic is particularly preferred because of low costs, easy adjustment of the particle diameter and easy surface treatment.

The number average particle diameter of the inorganic particles of the present invention is scaled up 10,000 times by a transmission electron microscope, and 300 particles picked up at random as primary particles are observed. The measurement value is calculated as the number average diameter of Ferret's diameter by image analysis.

The hydrophobicity of the aforementioned hydrophobic silica is preferably 50% in terms of the hydrophobicity expressed in the scale of wettability with reference to methanol (methanol wettability). If the hydrophobicity is less than 50%, the amount of change in endothermal energy AH tends to be greater than 10 J/g, and, as a result, the environmental memory tends to occur. More preferable hydrophobicity is 65% or more, and the most preferably hydrophobicity is 70% or more.

The methanol wettability representing the hydrophobicity evaluates the wettability of powdered silica with respect to methanol. The wettability is measured according to the following steps. 0.2 grams of powdered silica to be measured is added to 50 ml of distilled water in a 250 ml-volume beaker, and is stirred. Then methanol is dropped from a burette having its tip immersed under solution in a gently stirred state, until the entire powdered silica becomes wet. When the amount of methanol required to allow the powdered silica to be wet completely is assumed as “a” (m1), hydrophobicity is calculated according to the following equation (1):
Hydrophobicity=a/(a+50)×100 Equation (1)

The aforementioned hydrophobic silica is obtained by making hydrophobic the powdered silica generated according to the wet or dry method. The hydrophobic silica obtained by using hydrophobing agent to treat what is called fumed silica generated by dry method (vapor phase oxidation of silicic halogenated compound) is particularly preferred, because of a smaller site for moisture absorption. It can be manufactured by the prior art. For example, it can be manufactured by reaction of pyrolytic oxidation of the silicon tetrachloride gas in the oxyhydrogen flame. The following shows the basic reaction:
SiCl₄+2H₂+O₂→SiO₂+4HCl

Further, in this manufacturing process, for example, composite powder of silica and other metallic oxide can be obtained by using such metallic halogenated compound as aluminum chloride or titanium chloride, together with silicic halogenated compound.

Hydrophobic treatment of powdered silica can be provided by commonly known prior art methods. One of such methods is the drying method wherein hydrophobing solution dissolved in alcohol and others is sprayed onto the powdered silica dispersed in the form of clouds by stirring and other method, or evaporated hydrophobing agent is brought into contact with it. The other method is the wet method wherein powdered silica is dispersed in a solution and hydrophobing agent is dropped therein so that the agent will bond with powdered silica.

Commonly known compounds can be used as the hydrophobing agent. They will be listed below. These compounds can be used in combination.

The titanium coupling agent includes tetrabutyl titanate, tetraoctyl titanate, isopropyl triisostearoyl titanate, isopropyl tridesylbenzene sulfonyl titanate, and bis(dioctyl pyrophosphate) oxyacetate titanate.

The silane coupling agent includes γ-(2-aminoethyl) aminopropyl trimethoxy silane, γ-(2-aminoethyl)aminopropyl methyl dimethoxy silane, γ-methacryloxy propyl trimethoxy silane, N-β-vinylbenzyl aminoethyl-N-γ-aminopropyl trimethoxy silane hydrochloride, hexamethyl disilazane, methyl trimethoxy silane, butyl trimethoxy silane, isobutyl trimethoxy silane, hexyl trimethoxy silane, octyl trimethoxy silane, desyl trimethoxy silane, dodesyl trimethoxy silane, phenyl trimethoxy silane, o-methylphenyl trimethoxy silane and p-methylphenyl trimethoxy silane.

Silicone oil includes dimethyl silicone oil, methylphenyl silicone oil and amino-modified silicone oil.

It is preferred that 1 through 40 percent of hydrophobing agent by mass with respect to powdered silica be added for coating. Addition of 3 through 30 percent by mass is more preferred.

Hydrogen polysiloxane compound can be used as the aforementioned hydrophobing agent. The commonly available hydrogen polysiloxane compound has a molecular weight of 1,000 through 20,000. It is efficient in preventing generation of a black spot. It is effective to use methyl hydrogen polysiloxane compound in the final step of surface treatment.

In the present invention, hydrophobic silica subjected to the aforementioned process of hydrophobing, together with the binder, is incorporated into the surface layer of the organic photoconductor. The percentage of the silica particle in the surface layer is 1 through 20 percent by mass with respect to the binder. More preferable percentage is 2 through 15 percent by mass and the most preferable percentage is 2 through 10 percent by mass. If it is 20 percent by mass, the amount of change in endothermal energy AH of the photoconductor cannot be easily kept at 10 J/g or less. This may deteriorate the environmental memory and toner transferability easily. Conversely, if it is 1 percent by mass or less, cleaning failure or poor resistance to wear may occur easily.

It is also preferred that in addition to the binder resin of the aforementioned copolymer polycarbonates and hydrophobic inorganic particles, the electric charge transport substance and oxidation preventing agent be included in the electric charge transport layer as a surface layer. Similarly, it is preferred that 50 through 150 percent by mass of the aforementioned electric charge transport layer with respect to the binder resin and 1 through 10 percent by mass of the oxidation preventing agent be included therein.

The adoption of the aforementioned configuration provides the aforementioned membranous physical properties and surface roughness of the surface layer. An organic photoconductor having such a surface layer provides an electrophotographic image characterized by excellent sharpness ensured over a long time by improved resistance to damage and wear as well as easier removal of remaining toner.

The following describes the configuration of the organic photoconductor applicable to the present invention, other than the surface layer:

In the present invention, the organic photoconductor refers to an electrophotographic photoconductor, wherein the organic compound incorporates at least one of the electric charge generating function and electric charge transport function, which are the functions indispensable to the configuration of the electrophotographic photoconductor. It includes all the commonly known organic electrophotographic photoconductors such as a photoconductor consisting of a commonly known organic electric charge generating substance or organic electric charge transport substance, and photoconductor consisting of a polymeric material.

The layer configuration of the organic photoconductor of the present invention basically consists of an electric charge generating layer and electric charge transport layer or electric charge generating/transport layer (electric charge generating and transport functions provided by one and same layer) arranged on a conductive support. These layers may be coated with the surface layer having membranous physical properties of the present invention. In the most preferable configuration, the photoconductor layer is composed of an electric charge generating layer and a plurality of electric charge transport layers, and the electric charge transport layer as the topmost layer is formed as the surface layer of the present invention.

The following describes the specific configuration of the photoconductor used in the present invention:

Conductive Support

The conductive support used in the present invention is a sheet- or cylinder-shaped conductive support.

The cylindrical conductive support of the present invention refers to a cylindrical conductive supporting member capable of forming an image in an endless manner by rotation. A preferred conductive support has a straightness of 0.1 mm or less and a runout of 0.1 mm or less. If the straightness and runout get out of the aforementioned ranges, satisfactory image formation will run into difficulty.

A metallic drum made of aluminum or nickel, a plastic drum made of evaporated aluminum tin oxide or indium oxide, or a paper/plastic drum coated with conductive substance can be used as the conductive support. A preferred conductive support has a specific resistance not exceeding 10³ Ωcm at the normal temperature.

The conductive support used in the present invention can be the one with a porous-sealed alumite film formed on the surface. Alumite treatment is normally carried out in the acid bath containing chromic acid, sulfuric acid, oxalic acid, phosphoric acid, boric acid or sulfamic acid. The best results can be achieved by anodization treatment in the sulfuric acid. When the method of anodization treatment in the sulfuric acid is used, it is preferred that the concentration of sulfuric acid be 100 through 200 gram/l, and that of the aluminum ion be 1 through 10 grams/l, and anodization be performed at a solution temperature of about 20° C. and an applied voltage of about 20 volts, without the present invention being restricted thereto. The average thickness of the coating by anodization is 20 μm or less, normally and 10 μm or less, preferably.

Intermediate Layer

The aforementioned intermediate layer having a barrier function is preferably arranged between the conductive support and photoconductor in the present invention.

The intermediate layer of the present invention is preferred to have titanium oxide contained in the binder resin having a small percentage of water absorption. The titanium oxide particle should have a number average primary particle diameter of 10 nm or more without exceeding 400 nm, more preferably a number average primary particle diameter of 15 nm or more without exceeding 200 nm. If it is less than 10 nm, it is difficult to prevent a moire fringe pattern from being produced on the intermediate layer. In the meantime, if it is greater 400 nm, deposition of the titanium oxide in the solution coated on the intermediate layer is likely to occur, with the result that the uniform dispersion of titanium oxide in the intermediate layer cannot be obtained and black spots tend to appear. The intermediate layer coating solution, using the titanium oxide particles having the number average primary particle diameter kept within the aforementioned range, is characterized by excellent dispersion stability. Moreover, the intermediate layer formed of such coating solution is characterized by excellent environmental properties, and superb resistance to cracking, in addition to the black spot generation preventing function.

The titanium oxide used in this invention is branched, needle-shaped or granular. The titanium oxide particle having such a shape can be used when its crystal is of anatase, rutile or amorphous type. It is also possible to use the titanium oxide particle having two or more of these crystal types combined together. Of these types, the granular rutile type is the most preferred.

The titanium oxide particle of the present invention is preferred to have been subjected to surface treatment. In one of the surface treatment methods, multiple surface treatments are carried out, and the last treatment surface treatment in the multiple surface treatments is the surface treatment using the reactive organic silicon compound. Further, in the multiple surface treatments, it is preferred that at least one surface treatment be carried out using at least one of alumina, silica and zirconium. Reactive organic silicon compound should be used in the final step of surface treatment. Alumina, silica and zirconium treatment can be defined as a process of causing alumina, silica and zirconium to be deposited on the surface of the titanium oxide particle. Alumina, silica and zirconium deposited on this surface include the hydrate of alumina, silica and zirconium. The surface treatment of the reactive organic silicon compound signifies use of a reactive organic silicon compound as the treatment solution.

As described above, the surface treatment of the titanium oxide particle or the like is carried out at least twice, whereby the titanium oxide particle surface is uniformly coated. Use of the titanium oxide particle subjected to surface treatment as the intermediate layer ensures excellent dispersion of titanium oxide particles in the intermediate layer, and provides a superb photoconductor free of image defects such as black spots.

The compound expressed by the following general formula (1) can be mentioned as the aforementioned reactive organic silicon compound, which is not restricted to the following compound, if the compound is capable of condensation reaction with the reactive group on the titanium oxide surface.

General formula (1)
(R)n—Si—(X)4-n

(where “Si” denotes silicon atom, “R” an organic group wherein carbon is directly bonded to the silicon atom, “X” a hydrolytic group, and “n” an integer from 0 through 3).

In the organic silicon compound expressed by the general formula, the organic group represented by “R” wherein carbon is directly bonded to the silicon atom, include:

alkyl group such as methyl, ethyl, propyl, butyl, pertine, hexyl and octyl and didodecyl;

allyl group such as phenyl, tolyl, naphthyl and biphenyl;

epoxy-containing group such as γ-glusidoxypropyl and β-(3,4-epoxy cyclohexyl)ethyl;

(metha)-containing acryloyl group of γ-acryloxypropyl and γ-methacryloxypropyl;

hydrous group such as γ-hydroxypropyl, 2,3-dihydroxypropyloxypropyl;

vinyl-containing group such as vinyl and propenyl;

mercapto-containing group such as γ-mercaptopropyl;

amino-containing group such as γ-aminopropyl and N-β(aminoehyl)-γ-aminopropyl;

halogen-containing group such as γ-chloroprxyl, 1,1,1-trifluoropropyl, nonafluoropropyl and perfluorooctylethyl; and

nitro/cyano substitution alkyl group. Further, the hydrolytic group of “X” includes alkoxy group such as methoxy and ethoxy, halogen group and acyloxy group.

Further, the organic silicon compound expressed by the general formula (1) can be independent or two or more compounds can be combined.

In the case of the concrete compound of the organic silicon compound expressed in the general formula (1) where “n” is 2 or more, a plurality of Rs may be the same or different. Similarly, when “n” is 2 or less, a plurality of “X” can be the same or different. When two or more organic silicon compounds expressed by the general formula (1) are used, “R” and “X” can be the same or different among respective compounds.

Polysiloxane compound can be mentioned as the preferable reactive organic silicon compound. The polysiloxane compound having a molecular weight of 1,000 through 20,000 can be easily procured in general. It is effective in preventing black spots. Satisfactory results can be obtained by using the methyl hydrogen polysiloxane in the final step of surface treatment.

Photoconductor Layer

Electric Charge Generating Layer

The electric charge generating layer contains the electric charge generating substance (CGM). It may further contain a binder resin and other additives, as required.

For the organic photoconductor of the present invention, other phthalocyanine pigments, azo pigment, perylene pigment and azulenium pigment can be used as electric charge generating substances independently or in combination.

When a binder is used for the electric charge generating layer as a dispersant of the CGM, the commonly known resin can be used as a binder. The most preferable resins include formal, butyral, silicone resin, silicone-modified butyral resin and phenoxy resin. The preferred ratio between the binder resin and electric charge generating substance is 20 to 600 parts of electric charge generating substance with respect to 100 parts by mass of binder. Use of these resins minimizes the residual potential on increase resulting from repeated use. The preferred film thickness of the electric charge generating layer is 0.1 through 2 μm.

Electric Charge Transport Layer

The electric charge transport layer consists of a plurality of transport layers. The topmost electric charge transport layer has already been described. The configuration of the commonly known electric charge transport layer can be used in the electric charge transport layers other than the topmost one.

The electric charge transport layer contains the electric charge transport substance (CTM) and the binder resin prepared by dispersing the CTM and forming the film. It may further contain additives such as oxidation preventing agent, if required.

A commonly known electric charge transport substance (CTM) can be used as the electric charge transport substance (CTM). For example, it is possible to use triphenylamine derivative, hydrazone compound, styryl compound, benzidine compound and butadiene compound. These electric charge transport substances are normally resolved in the appropriate binder resin to form a layer. Of these substances, the CTM that minimizes the residual potential increase resulting from repeated use is the one characterized by high mobility and a ionization potential difference of 0.5 (eV) or less—preferably 0.30 (eV) or less—with respect to the combined CGM.

The ionization potentials of the CGM and CTM are measured by the surface analyzer AC-1 (by Riken Keiki Co., Ltd.).

Either thermoplastic resin or thermosetting resin can be used as the binder resin employed in the electric charge transport layer (CTL). It includes polystyrene, acryl resin, methacryl resin, polyvinyl chloride resin, vinyl acetate resin, polyvinyl butyral resin, epoxy resin, polyurethane resin, phenol resin, polyester resin, alkyd resin, polycarbonate resin, silicone resin, melamine resin, and copolymer resin including two or more recurring unit structures of these resins. In addition to these insulating resins, high molecular organic semi-conductor such as poly-N-vinyl carbazole can be mentioned. Of these, the most preferred one is the polycarbonate characterized by a small percentage of water absorption and excellent photographic properties.

The preferred ratio between the binder resin and electric charge transfer substance is 50 to 200 parts of electric charge transfer substance with respect to 100 parts by mass of binder.

The preferred film thickness of a plurality of electric charge transport layers is 10 through 50 μm in total. If the film thickness is less than 10 μm, the charging potential tends to be insufficient. If it exceeds 50 μm, sharpness will deteriorate.

The solvent or dispersant used for the formation of such layers as the intermediate layer, electric charge generating layer and electric charge transport layer includes n-butylamine, diethylamine, ethylenediamine, isopropanolamine, triethanolamine, triethyulene diamine, N, N-dimethyl formamide, acetone, methylethyl ketone, methylisopropyl ketone, cyclohexane, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolane, dioxane, methanol, ethanol, butanol, isopropanol, ethyl acetate, butyl acetate, dimethyl sulphoxide and methyl cellosolve. The present invention is not restricted to them. Dichloromethane, 1,2-dichloroethane, methylethyl ketone are preferably used. Further, these solvents can be used independently, or two or more of them can be used in combination.

The coating method used for the production of the organic photoconductor includes dip coating, spray coating and coating by regulation of circular quantity. When coating the upper layer of the photoconductor layer, spray coating or coating by regulation of circular quantity (typically represented by circular sliced hopper type method) is preferably used in order to minimize dissolution of the film on the lower layer or to achieve uniform coating. Use of the aforementioned coating by regulation of circular quantity is most preferred to coat the protective layer. Coating by regulation of circular quantity is disclosed in details in the Official Gazette of Japanese Patent Tokkaisho 58-189061.

The following describes the image forming apparatus using the organic photoconductor of the present invention:

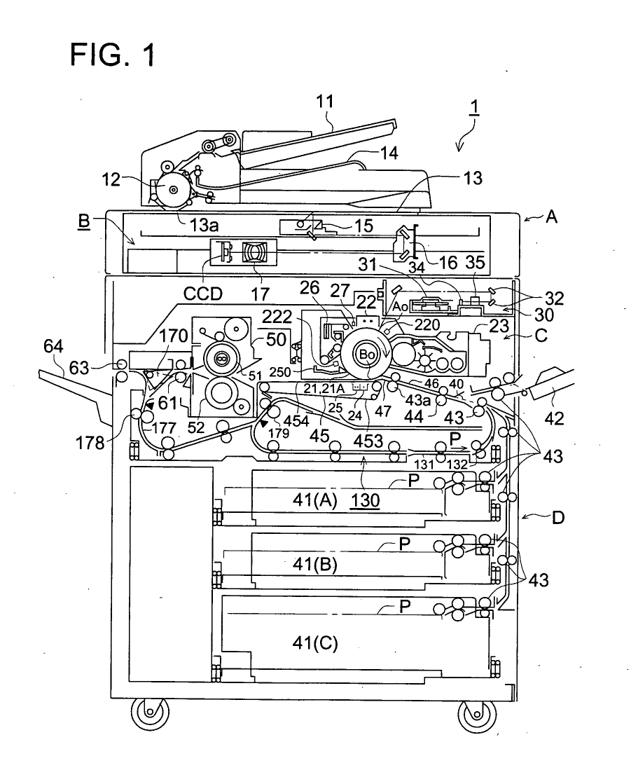

The image forming apparatus 1 showed in FIG. 1 is a digital image forming apparatus and comprises an image forming section A, an image processing section B, an image processing section C and a transfer sheet conveyance section D as a means for conveying the transfer sheet.

An automatic document feeder is arranged on the upper portion of the image processing section A. The documents placed on the document platen 11 are each separated and conveyed by the document conveyance roller 12 and the image is scanned by a reading position 13a. The document having been scanned is ejected onto the document ejection tray 14 by the document conveyance roller 12.

In the meantime, the image of the document placed on the platen glass 13 is scanned by the reading operation at a speed v through a first mirror unit 15 composed of an illumination lamp and a first mirror constituting the scanning optical system, and by the movement at speed v/2 in the same direction through a second mirror unit 16 consisting of a second mirror located at the V-shaped position and a third mirror.

The scanned image passes through a projector lens 17 and is formed on the light receiving surface of the image capturing device CCD as a line sensor. The linear optical image formed on the capturing device CCD is subjected to photoelectric conversion and is converted into the electric signal (luminance signal); then it is subjected to analog-to-digital conversion. In the image processing section B, it undergoes filtering and other processing, and the image data is stored in the memory temporarily.

The image processing section C image processing units such as a drum-shaped photoconductor 21 as an image carrier, a charging section 22 around it for charging the photoconductor 21, a potential detecting section 220 for detecting the potential on the surface of the charged photoconductor, a developing section 23, a transfer/conveyance belt apparatus 45 as a transfer means, a cleaning apparatus 26 of the aforementioned photoconductor 21 and a PCL 27 (pre-charge lamp) as an optical electric charge eliminator. They are arranged in the order of operation. Further, a reflected density detecting section 222 for measuring the reflected density of the patch image developed on the photoconductor 21 is arranged downstream from the developing section 23. The photoconductor 21 consists of a drum substrate coated with photoconductive compound. For example, the organic photoconductor 21A (called “OPC”), or furthermore, a hard-coated HC organic photoconductor 21B is used preferably. It is driven in the clockwise direction as illustrated.

The rotating photoconductor 21 is provided with uniform charging by the charging section 22. Then image exposure is carried out, based on the image signal called out of the memory of the image processing section B by an optical exposure system 30 as an optical image exposure means. The optical exposure system 30 as an optical image exposure means uses the laser diode (not illustrated) as a light source. The optical path is deflected by the reflecting mirror 32 through the polygon mirror 31, fθ lens 34 and cylindrical lens 35, and main scanning is carried out. Image exposure is performed at position Ao with respect to the photoconductor 21, and a latent image is formed by the rotation (sub-scanning) of the photoconductor 21. In one of the embodiments in the present invention, letter portions are exposed to form a latent image.

The latent image on the photoconductor 21 is reversed by the developing section 23, and a visible toner image is formed on the surface of the photoconductor 21. In the transfer sheet conveyance section D, sheet units 41(A), 41(B) and 41(C) as transfer sheet storage means incorporating the transfer sheets P of different sizes are arranged below the image forming unit. A manual sheet feed unit 42 for manual feed of the paper is located on its side. The sheet P selected from any one of them is fed along the conveyance path 40 by the guide roller 43, and is temporarily stopped by the register roller pair 44 for correcting the tilt and deviation of the sheet P. The sheet P is again fed and led to a conveyance path 40, a pre-transfer roller 43a, a sheet feed path 46 and an entry guide plate 47. The toner image on the photoconductor 21 is transferred to the transfer sheet P at the transfer position Bo by the transfer electrode 24 and separator electrode 25, while being carried by the transfer/conveyance belt 454 of the transfer/conveyance belt apparatus 45. The transfer sheet P is separated from the surface of the photoconductor 21 and is brought to a fixing apparatus 50 as a fixing means by the transfer/conveyance belt apparatus 45.

The fixing apparatus 50 contains a fixing roller 51 and a pressure roller 52. When the transfer sheet P passes between the fixing roller 51 and pressure roller 52, toner is fixed in position by heat and pressure. With the toner image having been fixed thereon, the transfer sheet P is ejected onto the ejection tray 64.

The above description is concerned with the case where an image is formed on one side of the transfer sheet. In the case of duplex copying, the ejection switching member 170 is switched and the transfer sheet guide 177 is opened. The transfer sheet P as paper is fed in the direction of an arrow showed in broken line.

Further, the transfer sheet P is fed downward by the conveyance device 178 and is switched back by the sheet reversing section 179. With the trailing edge of the transfer sheet P becoming the leading edge, the transfer sheet P is conveyed into the sheet feed unit 130 for duplex copying.

The conveyance guide 131 provided on the sheet feed unit 130 for duplex copying is moved in the direction of sheet feed by the transfer sheet P. Then the transfer sheet P is fed again by the sheet feed roller 132 and is led to the sheet conveyance path 40.

As described above, the transfer sheet P is again fed in the direction of the photoconductor 21, and the toner image is transferred on the back of the transfer sheet P. After the image has been fixed by the fixing section 50, the transfer sheet P is ejected to the ejection tray 64.

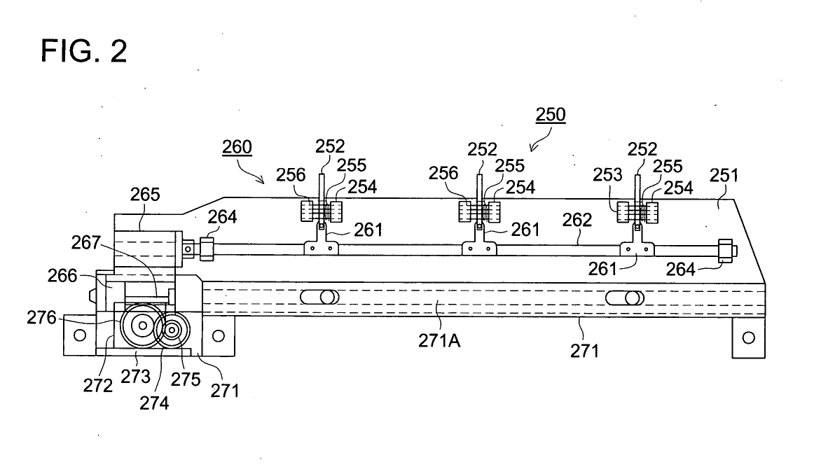

FIG. 2 is a plan showing the separation claw unit, FIG. 2 is its side view, and FIG. 4 is a side view of the separation claw. As shown in these figures, initial copying scratches by the claw are minimized and the occurrence of black streaks is prevented by switching the contact load of the separation claw 252 with respect to the organic photoconductor.

However, if the contact load of the separation claw 252 is reduced excessively to minimize the scratches, separation from the organic photoconductor 21 will fail and a paper jam will occur. Accordingly, the contact load must be kept within an appropriate range.

The following describes the contact load switching section 260 for switching the load of the separation claw 252 in contact with the organic photoconductor 21.

The contact load switching section 260 comprises:

a separation claw 252;

a torque spring 255 energizing the same;

a contact release plate 261 for contacting the separation claw 252 to the organic photoconductor 21 and for adjusting or releasing the contact load; and

a rotary type d.c. solenoid 265 directly coupled with the shaft 262 equipped with them.

The separation claw 252 is pivotally mounted on the rotary shaft 253 and is energized by the bearing 254. The power of the rotary type d.c. solenoid 265 is turned off by the torque spring 255. When the shaft 262 directly coupled to the rotary type d.c. solenoid 265 and rotatably mounted on the bearing 264 is returned and rotated by the spring force, the contact release plate 261 mounted on the shaft 262 is lowered, and the separation claw 252 comes in contact with the surface of the organic photoconductor 21. When the shaft 262 is energized and comes back to the original position, the contact release plate 261 is raised and releases the contact of the separation claw 252. Thus, contact state is disabled.

Further, the contact load between the separation claw 252 and organic photoconductor 21 can be reduced and switched by switching the voltage applied to the rotary type d.c. solenoid 265 and changing the contact pressure between the contact release plate 261 and separation claw 252.

As described above, switching of the contact load of the separation claw 252 with respect to the organic photoconductor 21 in the contact load switching section 260 is carried out by switching the voltage applied to the rotary type d.c. solenoid 265. To put it another way, the contact pressure applied to the pressure roller 52 at the position where the contact release plate 261 brings it in contact with the separation claw 252 reduces the force of energizing the separation claw 252 by the torque spring 255, according to the applied voltage value of the rotary type d.c. solenoid 265, and the contact load of the separation claw 252 with respect to the organic photoconductor 21 is adjusted to the appropriate value, whereby switching is enabled.

The contacted load on the separation claw 252 and the surface of the organic photoconductor 21 is preferably selected from the range of 0.98 through 7.84 mN and is set to an appropriate adjustment value.

In the meantime, a stepping motor 272 mounted on a fixed substrate 271 is engaged with the rack gear 267 mounted on the substrate 251 of the separation claw unit 250 through the gears 273, 274, 275 and 276, and the substrate 251 moves to a desired set position within the range of 5 mm on the right and left along the guide 271A of the fixed substrate 271, and stops at that position. In this manner, it is preferred that the contact position between the separation claw 252 and organic photoconductor 21 can be changed along the width in such a way as to prevent the contact along the width from being kept in the same state over a long time period.

The organic photoconductor of the present invention is applicable to the electrophotographic apparatus in general, such as an electrophotographic copying machine, laser printer, LED printer and liquid crystal shutter printer. It is also applicable over a wide range to the display, recording, light printing, prepress processing and facsimile machines where electrophotographic technology is applied.

### EXAMPLES

Referring to embodiments, the following describes the details of the present invention, without the present invention being restricted thereto. The parts in the following description refer to “parts by mass”.

Production of Photoconductor 1

A photoconductor 1 was produced as described below:

The surface of a 100 mm-diameter, 346 mm long cylindrical aluminum support member was machined to get a conductive support having a surface roughness of Rz=1.5 (μm).

<Intermediate Layer>

The following dispersion solution of the intermediate layer was diluted twofold with the same mixed solvent, and it was left to stand overnight. Then it was filtered by a filter (a 5-μm filter, Rigimesh by Nihon Pall Ltd.) to prepare the intermediate layer coating solution.

1 part of Polyamide resin CM 8000 (by Toray Industries, Inc.)

3 parts of titanium oxide SMT500SAS (by Teika Inc.)

10 parts of methanol

A sand mill was used as a dispersion machine to perform dispersion by a batch method for ten hours. Using the aforementioned coating solution, it was coated on the aforementioned support so that the film thickness in a dried state would be 2 μn.

<Electric Charge Generating Layer>

20 parts of Y type titanylphthalocyanine (Cu—Kαtitanylphthalosyanine having a black angle of 2θ (±0.2) and a maximum peak of 27.2 degrees according to characteristic X-ray diffraction spectral measurement),

10 parts of polyvinyl butyral resin (#6000-C: Denki Kagaku Kogyo Co., Ltd.),

700 parts of t-butyl acetate, and

300 parts of 4-methoxy-4-methyl-2-pentanone were mixed. A sand mill was used to disperse it for ten hours to prepare a solution for coating the electric charge generating layer. This solution was coated on the intermediate layer according to the dip coating method to produce an electric charge generating layer having a film thickness of 0.3 μm in a dried state.

<First Electric Charge Transport Layer>

225 parts of electric charge transport substance (4,4′-dimethyl-4″-(α-phenylstyryl) triphenylamine,

300 parts of polycarbonate (Z300 by Mitsubishi Gas Chemical Co., Ltd.),

6 parts of oxidation preventing agent (Irganox 1010 by Japan Chibageigie Co., Ltd.),

2000 parts of dichloromethane, and

1 part of silicone oil (KF-54 by Shinetsu Chemical Co. Ltd.) were mixed and dissolved to prepare a solution for coating the electric charge transport layer.

<Second Electric Charge Transport Layer>

225 parts of electric charge transport substance (4,4′-dimethyl-4″-(α-phenylstyryl) triphenylamine,

300 parts of polycarbonate (illustrated polycarbonate PC-1: viscosity average molecular weight 30,000)

60 parts of hydrophobic silica (hydrophobic silica given in Table 1: average particle diameter: 40 nm)

6 parts of oxidation preventing agent (LS2626 by Sankyo Co., Ltd.)

2000 parts of 1,3-dioxolane, and

1 part of silicone oil (KF-54 by Shinetsu Chemical Co. Ltd.) were mixed and were circulated and dispersed by a circulation/dispersion apparatus capable of applying ultrasonic waves, whereby a solution for coating the surface was prepared. This solution was coated on the electric charge transport layer according to the aforementioned method of coating by regulation of circular quantity until the film thickness reached 5 μm. Then it was dried at 110° C. for 70 minutes, whereby a photoconductor 1 was produced.

Production of photoconductors 2 through 15

Photoconductors 2 through 15 were produced using the same procedure as that used in the production of the photoconductor 1.

TABLE 1

| | | Number | | | |
|---|---|---|---|---|---|
| | | average | | | |
| | | primary | | | |
| | Surface | particle | | | |
| | layer binder | diameter | Hydrophobic | | |
| | (viscosity | (part) of | silica | | Hydrophobicity |
| Photo- | average | hydrophobic | processing | | of hydrophobic |
| conductor | molecular | silica | agent | Hydrophobic silica | silica |
| No. | weight) | (nm) | (part) | processing | (%) |
| 1 | PC-1(30,000) | 40 | 20 | Dimethyl silicone | 76 |
| 2 | PC-1(30,000) | 40 | 10 | Hexamethyl disilazane | 80 |
| 3 | PC-1(30,000) | 12 | 10 | methacryloxy silane | 72 |
| 4 | PC-2(28,000) | 40 | 20 | Hexamethyl disilazane | 73 |
| 5 | PC-3(20,000) | 40 | 20 | Hexamethyl disilazane | 73 |
| 6 | PC-4(30,000) | 40 | 20 | Hexamethyl disilazane | 73 |
| 7 | PC-1(30,000) | 7 | 40 | Hexamethyl disilazane | 72 |
| 8 | PC-1(30,000) | None | None | — | — |
| 9 | PC-1(30,000) | 40 | 80 | Dimethyl | 76 |
| | | | | dichlorosilane | |
| 10 | PC-2(28,000) | 40 | 10 | Hexamethyl disilazane | 73 |
| 11 | PC-2(28,000) | 95 | 10 | Octylsilane | 72 |
| 12 | PC-2(28,000) | 40 | 20 | Hexamethyl disilazane | 73 |
| 13 | PC-2(28,000) | 40 | 20 | Hexamethyl disilazane | 73 |
| 14 | PC-2(28,000) | 40 | 20 | Hexamethyl disilazane | 73 |
| 15 | PC-2(28,000) | 40 | 20 | Dimethyl silicone | 76 |

In the Table 1, the PC-4 denotes the polycarbonate having the following structure: 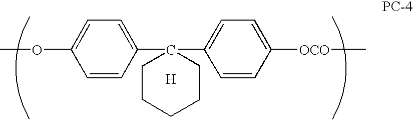
Evaluation

1. Surface roughness Ra

“Ra” can be defined as follows: Only the reference length is extracted from the roughness curve in the direction of the average line, and the X axis is assigned in the direction of the average line of this extracted portion, while the Y axis is assigned in the direction of longitudinal magnification. When the roughness curve is expressed as y=f(x), “Ra” a denotes the value, obtained from the following equation, expressed in terms of micrometer (μm).
Ra=1/1∫0¹|f(x)|dx

where “l” denotes a reference length

In the present invention, “l” is assumed as 2.5 mm, and the cutoff value as 0.08 mm.

The surface roughness meter (Surfcorder SE-30H by Kosaka kenkyujo Co., Ltd.) was used as a measuring instrument. Other measuring instruments can be used if the same results can be obtained within the tolerance limit.

Surface Roughness Measuring Conditions

Measuring speed (drive speed: 0.1 mm/sec.)

Measuring probe diameter (stylus: 2 μm)

2. Measuring the creep ratio

Measuring instrument: Fischerscope H100V (microscopic hardness measuring instrument) by Fischer Instruments

Used indenter: diamond, Vickers indenter

Load condition: Vickers indenter is pushed inside from the surface of the organic photoconductor at a speed of 4 mN/sec.

Load time: 5 sec.

Holding time: 5 sec.

Unloading condition: Remove the load at the same speed as that at the time of loading.

Test Sample

Similarly to the case of the aforementioned photoconductor, the intermediate layer, electric charge generating layer, first electric charge transport layer and second electric charge transport layer were arranged on the aluminum flat plate. The sample prepared by drying under the same conditions was fixed on the H100V equipment and the Vickers indenter was pushed inside perpendicularly to the sample to measure the creep ratio.

Measurement is carried out in the order of indenter loading (for 5 sec.), load holding (for 5 sec.: The creep ratio is the ratio of the deformation during this period) and unloading.

How to get the creep ratio
CHU (creep ratio)={(h2−h1)/h1}×100 (%)

h1: Indentation depth when the load weight (20 mN) has been reached (5 sec. after start of loading)

h2: Indentation depth after holding (5 sec.)

3. Image evaluation

A digital copying machine Konica 7075 by Konica Corporation (corona charging, laser exposure, reversing, static transfer, claw separation, blade cleaning and auxiliary brush roller adoption process for cleaning) was used as an device used for evaluation. Photoconductors 1 through 15 were mounted on this copying machine to evaluate images. To evaluate the cleaning performance and images, an original image consisting of a letter image, portrait image photograph, solid white image and solid black image having a pixel ratio of 7%, wherein each of these images has the size divided into four equal parts was copied to a A4-sized acid-free sheet. The 200,000 copies were taken in a high-temperature and high-humidity environment (at 30° C. 80% relative humidity) assumed as the severest conditions, and a halftone image, solid white image and solid black image were evaluated.

Evaluation Items and Evaluation Criteria

Image density (RD-918 by Macbeth was used for this evaluation. Evaluation was made at the relative reflection density where the reflection density of paper was “0”).

A: 1.2 or more: Satisfactory

B: 0.8 or more: Without practical problem

C: less than 0.8: With practical problem

Sharpness (Upon termination of copying 200,000 sheets, a letter image was used to test the sharpness.)

The 3-point and 5-point letter images were created and evaluated according to the following criteria:

A: Both the 3- and 5-point sizes are clear and easy reading was confirmed.

B: The 3-point size is partly unreadable, but the 5-point size is clear and easily readable.

C: The 3-point size is hardly readable. The 5-point size is partly or wholly unreadable.

Toner transferability (After copying 200,000 sheets, a 60 mg/cm² image was formed on the photoconductor and the amount of toner (fmg/cm²), per unit area, attached to the transfer sheet was measured. Then the transfer ratio was calculated according to the following calculation.)
Toner transfer ratio=(f/60)×100

A: Toner transfer ratio 85% or more: satisfactory

B: Toner transfer ratio 65 through 84%: No practical problem

C: Toner transfer ratio 64% or less: Practical problem

Cleaning performance (After copying 100,000 and 200,000 sheets, copying was performed on continuous ten A3-sized sheets, and evaluation was made to see if cleaning failure occurred on the solid white portion or not.)

A: Insufficient toner removal occurs after copying 200,000 sheets.

B. No insufficient toner removal occurs until 100,000 sheets have been copied.

C. Insufficient toner removal occurs before 100,000 sheets are copied.

Resistance to damage (All of 200,000 copied images were checked to see if an damage has been caused to the image by the separation claw or not. Also a check was made for every 10,000 copies to see if a damage has occurred on the surface of the photoconductor by the separation claw.)

A: There is no damage on the copy image or the surface of the photoconductor.

B: There is a slight damage on the surface of the photoconductor, but no damage is found on the copied image, caused by the separation claw.

C: There is a clear damage on the surface of the photoconductor, and a damage is found on the copied image due to the separation claw.

Other Evaluation Conditions

Other evaluation conditions using the aforementioned 7075 were set to the following:

Charging Condition

Charging device: scorotron charger where initial charging potential was set at −750 volts.

Exposure Conditions

The amount of exposure was set in such a way that the exposure section potential becomes −50 volts

Development conditions

DC bias; −550 volts

The toner developer using the externally added titanium oxide was used for the coloring particles, having a volume mean particle diameter of 7.3 μm, prepared by the polymerization method, and comprising the carrier coated with the insulating resin using Ferrite as a core, the coloring agent such as a carbon black using the styrene acryl resin as the major material, the electric charge control agent, and the polyolefin of low molecular weight.

Transfer Condition

Transfer electrode; Corona charging.

Separation Conditions

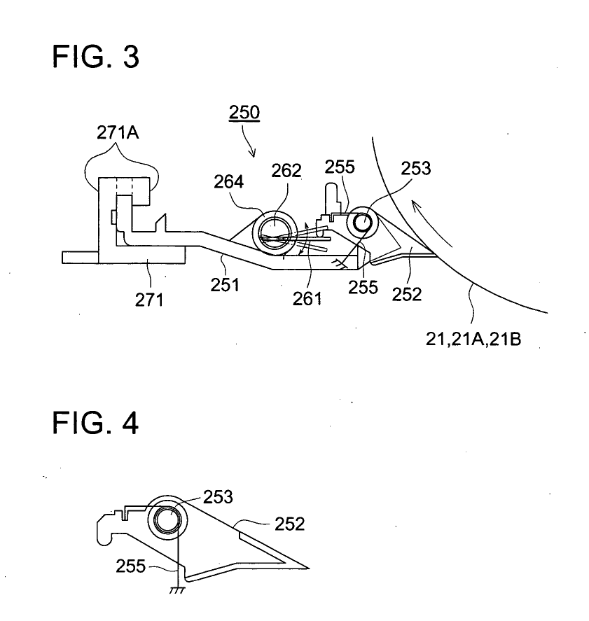

The separation section of the separation claw unit described with reference to FIGS. 2 through 4 was used.

Material of separation claw: It is basically made of polyamideimide (PAI) coated with polytetrafluoroethylene (PTFE)

Contact load with respect to photoconductor: 5.6 mN

Cleaning Conditions

A cleaning blade having a hardness of 70 deg., a rebound elasticity of 65%, a thickness of 2 mm and a free length of 9 mm was brought into contact with the cleaning section according to the weight loading method in the direction of the counter so that the linear pressure would be 18 g/cm.

Table 2 shows the result of evaluation.

TABLE 2

| Photo- | Surface | Creep | | | | | Resistance | |
|---|---|---|---|---|---|---|---|---|
| conductor | roughness | ratio | | | Toner | Cleaning | to | |
| No. | Ra(μm) | (%) | Image | Sharpness | transferability | performance | damage | Remarks |
| 1 | 0.06 | 3.06 | A | A | A | A | B | Included in the Invention |
| 2 | 0.04 | 2.99 | A | A | A | A | B | Included in the Invention |
| 3 | 0.02 | 2.8 | A | A | B | A | B | Included in the Invention |
| 4 | 0.05 | 2.86 | A | A | A | A | B | Included in the Invention |
| 5 | 0.03 | 2.6 | A | A | A | A | A | Included in the Invention |
| 6 | 0.07 | 3.62 | B | B | B | C | C | Excluded from the invention |
| 7 | 0.25 | 2.05 | B | B | B | C | B | Excluded from the invention |
| 8 | 0.009 | 2.75 | C | B | C | B | B | Excluded from the invention |
| 9 | 0.08 | 0.82 | C | C | B | C | B | Excluded from the invention |
| 10 | 0.04 | 2.45 | A | A | A | B | A | Included in the Invention |
| 11 | 0.09 | 2.67 | A | A | B | B | A | Included in the Invention |
| 12 | 0.06 | 2.35 | A | A | A | B | A | Included in the Invention |
| 13 | 0.05 | 2.30 | A | A | A | A | A | Included in the Invention |
| 14 | 0.06 | 2.35 | A | A | A | A | A | Included in the Invention |
| 15 | 0.08 | 2.42 | A | B | A | A | A | Included in the Invention |

With respect to both the creep ratio and surface roughness Ra, the photoconductors 1 through 5 and 10 through 15 within the scope of the present invention have exhibited excellent characteristics in each of the evaluation items such as the image density, toner transferability, sharpness, cleaning performance and resistance to damage. The photoconductor 6 (creep ratio: 3.62) outside the scope of the present invention is inferior in cleaning performance and resistance to damage. The photoconductor 9 (creep ratio: 0.82) is insufficient in image density, sharpness and cleaning performance. Further, the photoconductor 7 (surface roughness Ra: 0.25 μm) is poor in cleaning performance, while the photoconductor 8 (surface roughness Ra: 0.009 μm) is reduced n toner transferability and image density.

As is apparent from the embodiment, use of the organic photoconductor of the present invention provides an electrophotographic image characterized by excellent toner transferability and superb performance for removing remaining toner, even when a great number of sheets have been copied under the conditions of high temperature and high humidity. At the same time, use of the organic photoconductor of the present invention also provides improved resistance to damage and excellent sharpness of the electrophotographic image.

What is claimed is:

1. An organic photoconductor comprising a conductive support having thereon a photoconductor layer, wherein the creep ratio of the surface of the photoconductor layer is not less than 1% and less than 3.5%, and the surface roughness Ra is not less than 0.02 μm and less than 0.1 μm.

2. The organic photoconductor of claim 1, wherein the creep ratio is defined as the value obtained by following equation:
CHU (creep ratio)={(h2−h1)/h1}×100 (%)
wherein h1: indentation depth when the applied load reached at 20 mN from start of applying loads, and
h2: indentation depth after holding the applied load at 20 mN, and
the measurement conditions:
a) Indenter: Diamond Vickers indenter
b) Load condition: A test piece was mounted on the Fischerscope H100V that is a microscopic hardness measuring instrument by Fischer Instruments conforming to the hardness test method based on ISO 14577, and the Vickers indenter was forced inside from the test piece surface at the rate of 4 mN/sec. in the direction perpendicular to the test piece
c) Load time: 5 sec.
d) Holding time: 5 sec.
e) load removal: Load was removed at the same rate as that of the load, and
f) Test piece: The organic photoconductor was arranged on a flat aluminum plate, and was dried to prepare the test piece.

3. An organic photoconductor comprising a conductive support having thereon an electric charge generating layer and an electric charge transport layer in that order,
wherein the electric charge transport layer is composed of multiple layers including a surface layer which is outermost layer of the electric charge transport layer, and
wherein the creep ratio of the surface layer not less than 1% and less than 3.5%, and the surface roughness Ra is not less than 0.02 μm and less than 0.1 μm.

4. The organic photoconductor of claim 3, wherein the surface layer contains inorganic particles having a number average diameter of not less than 10 nm and less than 100 nm.

5. The organic photoconductor of claim 4, wherein the inorganic particles are hydrophobic silica.

6. The organic photoconductor of claim 3, wherein the surface layer binder is a copolymer polycarbonate resin.

7. An image forming method, comprising the steps of:
charging a surface of an organic photoconductor containing a conductive support having thereon a photoconductor layer;
exposing the surface of the organic photoconductor to form a latent image;
developing the latent image with toners to form a visible toner image; and
transferring the visible toner image onto a toner image receiving member,
wherein the creep ratio of the surface of the photoconductor layer is not less than 1% and less than 3.5%, and the surface roughness Ra is not less than 0.02 μm and less than 0.1 μm.

8. An image forming apparatus comprising:
a charging device for charging a surface of an organic photoconductor containing a conductive support having thereon a photoconductor layer;
an exposing device for exposing the surface of the organic photoconductor to form a latent image;
a developing device for developing the latent image with toners to form a visible toner image; and
a transferring device for transferring the visible toner image onto a toner image receiving member,
wherein the creep ratio of the surface of the photoconductor layer is not less than 1% and less than 3.5%, and the surface roughness Ra is not less than 0.02 μm and less than 0.1 μm.

9. A process cartridge designed in such a way that the process cartridge can be loaded into an image forming apparatus and unloaded therefrom, comprising:
an organic photoconductor containing a conductive support having thereon a photoconductor layer; and at least one of a charging device for charging a surface of an organic photoconductor containing a conductive support having thereon a photoconductor layer, an exposing device for exposing the surface of the organic photoconductor to form a latent image, a developing device for developing the latent image with toners to form a visible toner image, and a transferring device for transferring the visible toner image onto a toner image receiving member,
wherein the creep ratio of the surface of the photoconductor layer is not less than 1% and less than 3.5%, and the surface roughness Ra is not less than 0.02 μm and less than 0.1 μm.
